(19) United States
(12) Patent Application Publication
(10) Pub. No.: US 2018/0312100 A1
(43) Pub. Date: Nov. 1, 2018

(54) ADJUSTABLE APPARATUS FOR SECURING AN ARTICLE

(71) Applicant: Denis DURAND, St-Barthelemy (CA)

(72) Inventor: Denis DURAND, St-Barthelemy (CA)

(21) Appl. No.: 15/882,153

(22) Filed: Jan. 29, 2018

(30) Foreign Application Priority Data
Feb. 9, 2017 (GB) GB1702179.1

(51) Int. Cl. B60P 7/08

(52) U.S. Cl. CPC B60P 7/083

(57) ABSTRACT

An apparatus for securing an article includes a belt with a first connecting member and a free end. The belt has a lockable portion, which is located between the connecting member and the free end. An elongate resilient strap has a locking member which is located at a strap end and another connecting member is located at the other strap end. The locking member has a lockable end that locks the lockable portion.

### CROSS-REFERENCE TO RELATED APPLICATION

Priority is hereby claimed to previously filed United Kingdom patent application number GB1702179.1, filed Feb. 9, 2017, the entire contents of which are hereby incorporated by reference.

### TECHNICAL FIELD

The present relates generally to securing apparatus, and more particularly to a belt and strap combination to secure articles to an immovable object.

### BACKGROUND

Outdoor activities that require temporary shelter from the weather such as wind, rain or snow, often employ tents or tarpaulins. Such temporary shelters need to be tethered to an immovable object such as a frame, the ground or even a tree, to prevent them from blowing away. Also, moving articles such as luggage between locations often require securing those articles to a roof rack or directly to the roof of a vehicle. The use of resilient belts or cords to temporarily or permanently secure articles to an immovable structure is well known. For example, an elongate strap with two connecting ends can be used to temporarily secure luggage to the roof of a car or in the rear of a trailer. In the case of so-called bungee cord, two hooks allow rudimentary attachment of both ends of the cord to a frame, which is separately connected to the roof. The strength of the bungee cord lies in the elasticity of the material and the frictional resistance of the cord outer material against the luggage surface. This holds the luggage in place. The cord, however is limited by its length, and often fails if the hooks are not secured sufficiently to the frame. Moreover, the size of the luggage to be secured is limited by the length of the cord. Thus, the bungee cord system is not typically used to secure items that require adjustment to tighten or loosen the attachment system.

To overcome this problem, a number of different securing straps or belts have been developed to help quickly and efficiently secure items. Examples of these include the following:

U.S. Pat. No. 3,718,315 to Huber for “Strap Adjuster Devices”;

U.S. Pat. No. 4,584,741 to Kawahara for “Clasping Device”;

U.S. Pat. No. 5,402,557 to Dalen for “Dynamic Self-Adjusting, Tie-Down Device for Transportable Items;

U.S. Pat. No. 5,623,750 to Nasin for “Adjustable Elastic ad Inelastic Strap Apparatus”;

U.S. Pat. No. 7,020,933 to Chang for “Connector Device for Suspending Straps”;

U.S. Pat. No. 8,695,176 to Gangahedkar for “Adjustable Tarp Strap”;

U.S. Pat. No. 9,376,050 to Gill for “Resilient Strap Member with Side Rail Assembly”;

United Kingdom patent number UK 1,297,146 to Roberts for “Improvements in or Relating to Strap Tensioning Buckles”;

Published United States patent application number US 2002/0138952 to Chou for “Fastening Rope”;

Published United States patent application number US 2005/0177984 to Huang for “Strap Fastener Set”;

Published United States patent application number US 2006/0037178 to Sullhoff for “Self-Adjusting Tie-Down Strap”; and

Published United States patent application number US 2015/0232012 to Wright for “Cam Buckle Assembly with In-Line Elastic Member”.

Many attachment apparatuses are well known and include ratchet straps, which provide an adjustable way to securely attach Some attachment means such as ratchet straps offer an adjustable means for attaching an object in a secure manner. Other attachment means are stretchable such as bungee cords or rubber straps, but disadvantageously the stronger the strap type, the less it is adjustable or stretchable.

Thus, there is a need for an improved securing apparatus which employs the advantages of a resilient material, but has the means to permit adjustability of length without losing its strength.

### BRIEF SUMMARY

I have designed a new and unobvious apparatus which significantly reduces, or essentially eliminates, the problems of the aforesaid designs. My design while mechanically simple, is extremely elegant and provides significant advantages over contemporary designs. To achieve this, my design incorporates a dual strap design with a cam buckle, which has a resilient, extendable strap located at one end and a webbing belt located at the other end. This provides an adjustable strap which provides a strong, yet easily adjustable securing apparatus

Accordingly, in one embodiment there is provided an apparatus for securing an article, the apparatus comprising:

a belt having a first connecting member and a free end, the belt having a lockable portion located between the first connecting member and the free end; and

an elongate resilient strap having a locking member located at a first strap end and a second connecting member located at a second strap end, the locking member having a lockable end for lockably receiving therein the lockable portion.

In one example, the first and second connecting members are sufficiently spaced apart to locate the belt and the elongate resilient strap over the article and to secure the first and second connecting members to an immovable object.

In another example, the locking member includes a locking bar, the lockable portion of the belt being folded thereover, the locking member lockingly engages the lockable portion of the belt in a locked configuration once a desired belt length is achieved. The locking member disengages the lockable portion of the belt to permit a user to move the belt to achieve the desired belt length. The locked configuration, the first connecting member is located away from the locking member and generally orthogonal to the free end of the belt.

In another example, the belt is a non-resilient web material.

In yet another example, the locking member includes a locking bar, the first strap end being connected to the locking member opposite the locking bar. The locking member is molded into the first strap end. The first strap end has a strap end width that is larger than a resilient strap width.

In still another example, the second connecting member is located away at the second strap end.

In another example, the first strap end is hingeably connected to the locking member.

In another example, the locking member is a cam buckle

In another example, the elongate resilient member is made of rubber.

In another example, the first connecting member is an S-shaped hook.

In another example, the second connecting member is an S-shaped hook.

In another example, the belt is wider than the width of the resilient strap.

Accordingly, in another embodiment, there is provided a dual strap and belt apparatus for securing an article to an immobile object, the apparatus comprising:

a belt having a first hook member and a free end, the belt having a lockable portion located between the first hook member and the free end; and

an elongate resilient strap having a locking member located at a first strap end and a second hook member located at a second strap end, the locking member having a lockable end for lockably receiving therein the lockable portion, the elongate resilient strap having a length that is extendable to achieve a desired length.

Accordingly, in alternative embodiment, there is provided a stretchable tie down strap has a cam buckle tie down strap having one end formed by an extendable strap having a hook member; the stretchable tie down strap has a cam buckle and a long webbing ending with a hook member; the extendable strap is molded over part of the cam buckle so as to be permanently attached thereto.

### BRIEF DESCRIPTION OF THE DRAWINGS

These and other features of that described herein will become more apparent from the following description in which reference is made to the appended drawings wherein:

FIG. 1 is a perspective view of an embodiment of an apparatus showing two a belt and a resilient strap with two hook members;

FIG. 2 is a top view of the apparatus of FIG. 1;

FIG. 3 is a side view of the apparatus of FIG. 1 showing the location of the hook members relative to a buckle with a detailed view showing the interface between the buckle and the extendable strap; and

FIG. 4 is a detailed view of a hinge connection between the buckle and the resilient strap.

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present

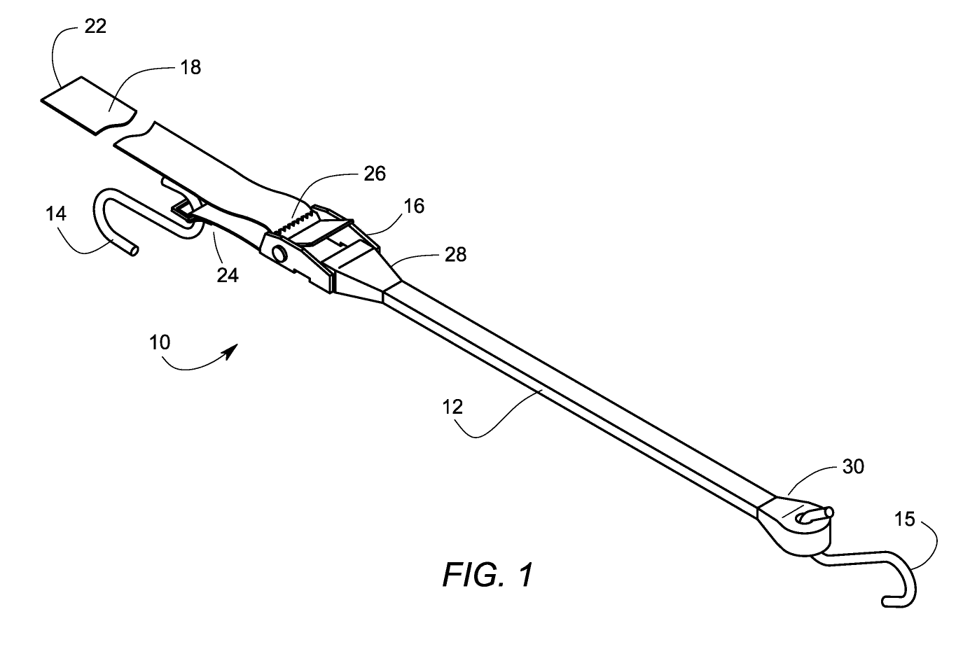

Referring now to FIG. 1, a securing apparatus is illustrated generally at 10. In the configuration shown, the apparatus 10 is in an adjusting configuration and is laid out in a planar manner to best illustrate the constitutive parts. Broadly speaking, the apparatus 10 includes an elongate, strap 12, first and second connecting member 14, 15, a locking member 16 and a belt 18. Depending on the desired use, the elongate strap 12 is constructed from a resilient material such as rubber or a polymeric material. The resilience of the material permits stretching (or expansion) in a linear manner of the strap 12 so as to accommodate articles of various sizes and shapes. The belt 18, on the other hand, is constructed from a flexible web material, which although not resilient, is lightweight and permits a user to quickly and easily adjust the length of the belt 18 using the locking member 16 as will be described below. It is also desirable that the materials from which the elongate strap 12 and the belt 18 are constructed are water-proof, and sufficiently hard-wearing to ensure longevity of use. As best illustrated in FIG. 1, the first and second connecting members 14, 15 are S-shaped hooks, which can be easily inserted into their respective connecting ends holes

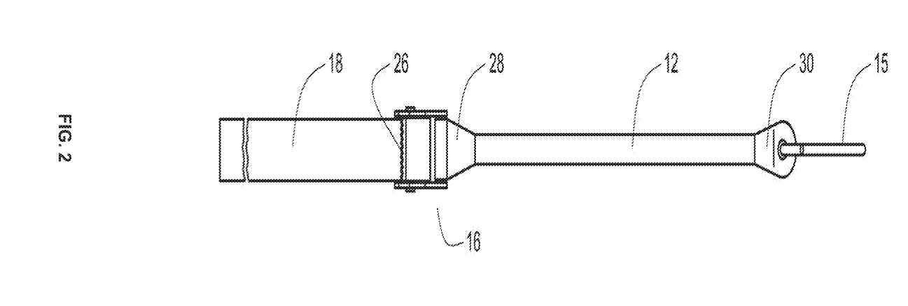

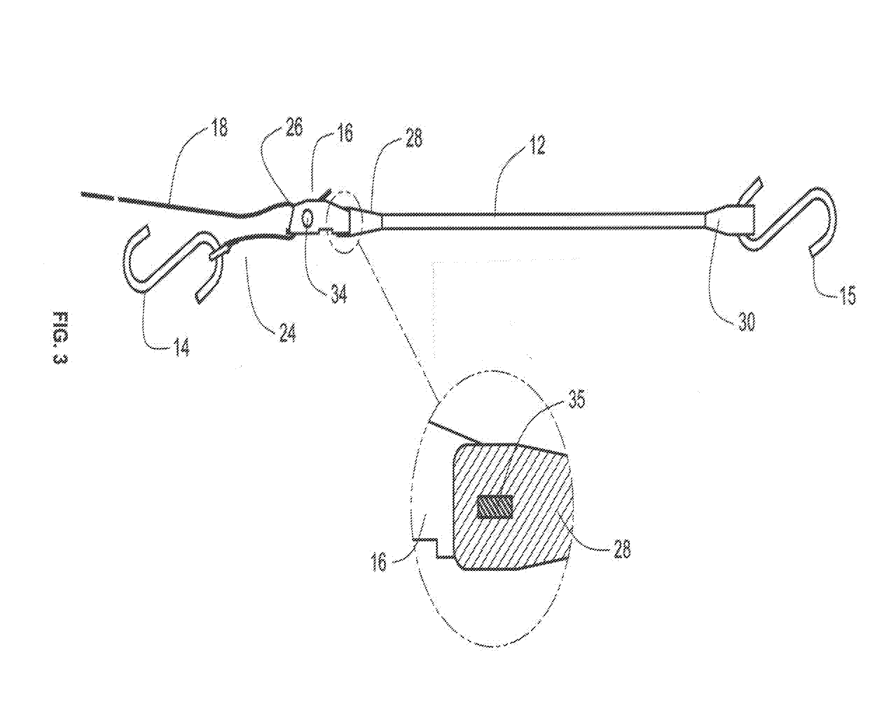

Referring still to FIG. 1, and now to FIGS. 2 and 3, the belt 18 includes a free end 22, a connecting end 24, which includes the first connecting member 14, and a lockable portion 26 that is located between the free end 22 and the connecting end 24.

As best illustrated in FIG. 2, the elongate resilient strap 12 includes a first strap end 28 and the second connecting member 15 located at a second strap end 30. The locking member 16 is located at the first strap end 28.

Depending on the combined length of the belt 18 and the elongate resilient strap 12, the two connecting members 14, 15 are spaced apart a sufficient distance so as to locate the apparatus 10 over the article or articles, or to secure a tent or tarpaulin to an immovable object such as a frame, a wall or the ground.

As best illustrated in FIG. 3, the locking member 16 has a lockable end 32, which is configured to lockably receiving the lockable portion 26 of the belt 18. The locking member 16 includes a locking bar 34. The lockable portion 26 of the belt 18 is folded over the locking bar 34, where the locking member 16 lockingly engages the lockable portion 26 of the belt 18 in a locked configuration once a desired belt length is achieved. The locking member 16 disengages the lockable portion 26 of the belt 18 to permit a user to move the belt 18 to achieve the desired belt length. The locked configuration, the first connecting member 14 is located away from the locking member 16 and generally orthogonal to the free end 22 of the belt 18.

As best illustrated in FIGS. 1, 2, and 3, the first strap end 28 is connected to the locking member 16 opposite the locking bar 34. In one example, the locking member 16 is molded into the first strap end 28 about a securing bar 35. As best seen in FIG. 2, the first strap end 28 has a strap end width that is larger than a resilient strap width. The second connecting member 15 is located away from the first strap end 28 at the second strap end 30. In the examples illustrated the locking member 16 is a so-called cam buckle, the operation of which is well-known to those skilled in the art. Furthermore, as seen in FIG. 3, the belt 18 is wider than the resilient strap 12.

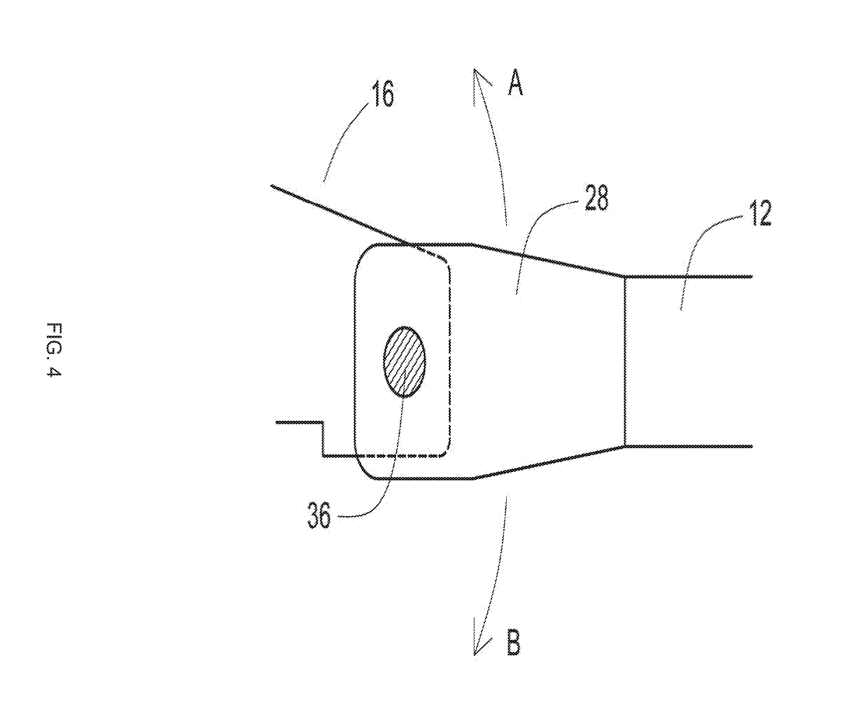

Referring now to FIG. 4, in applications which require hingeably movement of the resilient strap 18 relative to the locking member 16, the first strap end 28 may be hingeably connected to the locking member 16. A hinge 36 may be located in the locking member 15 opposite the locking bar 34 to permit movement as indicated by arrows A and B.

As will be clear to one of ordinary skill in the art, the apparatus 10 can be used to secure one or more pieces of luggage to either a fame or a roof of a vehicle, or any other article, bulky or otherwise, to an immovable support. Furthermore, the apparatus can be used to secure tarpaulins to the ground or tents to trees and the like. an apparatus for securing an article, the apparatus comprising:

It should be noted that my apparatus includes novel and unobvious features which are different from those typically used in short end webbing and hooks in ratchet tie down straps of.

Indeed, the stretchable (resilient) tie down strap is mostly comprised of parts found in ratchet tie down straps of the prior art, but the extendable, resilient strap 18 is molded over part of the cam buckle 16 to ensure a permanent connection between the two.

### Operation

Referring to FIG. 1, a simple operation of the apparatus will now be described. Upon securing an object or article to the immovable object or surface, the webbing 18 is tightened using the cam buckle 16 by pulling the free end of the belt 18 to achieve the desired length and tightness of the apparatus 10. To undo the apparatus 10, the user simple pulls the strap 12, without having to disengage the cam buckle 16, which may be difficult to do, especially in cold weather or in space-restricted areas.

### Other Embodiments

From the foregoing description, it will be apparent to one of ordinary skill in the art that variations and modifications may be made to the embodiments described herein to adapt it to various usages and conditions.

What is claimed is:

1. An apparatus for securing an article, the apparatus comprising:
a belt having a first connecting member and a free end, the belt having a lockable portion located between the first connecting member and the free end; and
an elongate resilient strap having a locking member located at a first strap end and a second connecting member located at a second strap end, the locking member having a lockable end for lockably receiving therein the lockable portion.

2. The apparatus, according to claim 1, in which the first and second connecting members are sufficiently spaced apart to locate the belt and the elongate resilient strap over the article and to secure the first and second connecting members to an immovable object.

3. The apparatus, according to claim 1, in which the locking member includes a locking bar, the lockable portion of the belt being folded thereover, the locking member lockingly engages the lockable portion of the belt in a locked configuration once a desired belt length is achieved.

4. The apparatus, according to claim 3, in which the locking member disengages the lockable portion of the belt to permit a user to move the belt to achieve the desired belt length.

5. The apparatus, according to claim 3, in which in the locked configuration, the first connecting member is located away from the locking member and generally orthogonal to the free end of the belt.

6. The apparatus, according to claim 1, in which the belt is a non-resilient web material.

7. The apparatus, according to claim 1, in which the locking member includes a locking bar, the first strap end being connected to the locking member opposite the locking bar.

8. The apparatus, according to claim 7, in which the locking member is molded into the first strap end.

9. The apparatus, according to claim 7, in which the first strap end has a strap end width that is larger than a resilient strap width.

10. The apparatus, according to claim 1, in which the second connecting member is located away at the second strap end.

11. The apparatus, according to claim 1, in which the first strap end is hingeably connected to the locking member,

12. The apparatus, according to claim 1, in which the locking member is a cam buckle

13. The apparatus, according to claim 1, in which the elongate resilient member is made of rubber.

14. The apparatus, according to claim 1, in which the first connecting member is an S-shaped hook.

15. The apparatus, according to claim 1, in which the second connecting member is an S-shaped hook.

16. The apparatus, according to claim 1, in which the belt is wider than the width of the resilient strap.

17. A dual strap and belt apparatus for securing an article to an immobile object, the apparatus comprising:
a belt having a first hook member and a free end, the belt having a lockable portion located between the first hook member and the free end; and
an elongate resilient strap having a locking member located at a first strap end and a second hook member located at a second strap end, the locking member having a lockable end for lockably receiving therein the lockable portion, the elongate resilient strap having a length that is extendable to achieve a desired length.
